(19) United States
(12) Patent Application Publication
(10) Pub. No.: US 2002/0174104 A1
(43) Pub. Date: Nov. 21, 2002

(54) Server automatically issuing instruction concerning order for consumables

(76) Inventor: Katsuhito Yokoyama, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/143,782

(22) Filed: May 14, 2002

(30) Foreign Application Priority Data
May 16, 2001 (JP) 2001-146601(P)

(51) Int. Cl. G06F 7/00

(52) U.S. Cl. 707/1

(57) ABSTRACT

A print server receives a job ticket from a client to calculate, according to the job ticket, the number of sheets required for an operation performed on the sheets and the number of sheets in stock that can be used for the operation. The server further calculates the time required for the operation performed on the sheets in stock, and calculates a free space of a storage location that is left after the operation performed on the sheets in stock. The server accordingly plans a schedule for ordering lacking sheets, in order to allow sheets that can be accommodated in the free space to be restocked before completion of the process on the sheets in stock. This process is repeated to continue the operation.

This application is based on application No. 2001-146601 filed in Japan, the contents of which are hereby incorporated by reference.

### BACKGROUND OF THE INVENTION

1. Field of the Invention

The present invention relates to a server, a method for managing consumables, a program for managing consumables, and a system. In particular, the invention relates to a server, a consumable management method, a consumable management program, and a system for efficiently providing instructions concerning orders for consumable items.

2. Description of the Related Art

Recent years have often seen a working pattern, according to which such appliances as printers and copying machines are connected to a network to be shared in a workgroup including a plurality of clients.

Nowadays there is also a working pattern of printing, according to which printing or bookbinding is done at a client's request sent by facsimile or on the Internet.

According to a conventional method regarding these working patterns, a user receives from a client an instruction about printing and checks required consumable items like sheets of paper for example. Then, the user determines if the consumables for printing are out of stock or not, and orders required consumables from a supplier.

This lack of stock of required consumables causes an unavoidable downtime before delivery of the consumables. Such a lack of stock consequently causes downtime in activities of many clients. Then, the clients suffer from delays in their activities as well as losses due to the delays.

In order to avoid the shortage of stock, various consumable items must be kept in stock. Accordingly, in development of a business, it takes considerable cost to secure a certain storage space for storing the consumables.

Thus, in the business environment where such devices as printers and copying machines are connected to a network, management or control of the inventory of consumables is a critical factor in building up the business.

Japanese Patent Laying-Open No. 2000-137418 discloses a method of managing the inventory of consumables, according to which it is notified when consumables should be ordered. This notification is given when the number of consumables in stock reaches a reference value which is set in advance by a user.

Japanese Patent Laying-Open No. 8-152816 discloses a method according to which it is determined when consumables become out of stock based on the average number of consumables consumed in the past and a consumable delivery plan is accordingly formed.

However, if the method disclosed in Japanese Patent Laying-Open No. 2000-137418 is employed, it is necessary to stock the consumables satisfying the reference value that are enough to use in printing in accordance with an instruction from a client. A resultant problem is that a storage space for stocking the consumables meeting the reference value must be secured.

Moreover, according to the method disclosed in Japanese Patent Laying-Open No. 8-152816, the consumable delivery plan is created by estimating the time when the consumables become out of stock based on the average number of consumables used in the past. Here, there is a problem that the consumable delivery plan is not formed in accordance with the number of actually used consumables.

In addition, according to these methods described above, a user who confirms the notified ordering time has to provide instructions concerning orders.

### SUMMARY OF THE INVENTION

One object of the present invention is thus to provide a server, a consumable management method, a consumable management program, and a system, by which the inventory of or the number of consumables in stock can be reduced, without downtime due to occurrence of stockout, and, in accordance with a plan, instructions can be issued concerning delivery of consumables.

The above-object is achieved by a server including components detailed below. According to one aspect of the present invention, the server includes a stock storage unit storing the number of consumables in stock that are to be used by a device connected via a network, a free space storage unit storing a free space of a storage location where the consumables are stocked, a receiving unit receiving from a client an instruction concerning an operation to be performed by the device, a calculating unit calculating the number of consumables used by the device according to the instruction concerning the operation, and a planning unit planning a schedule for ordering the consumables according to the number of consumables in stock, the number of consumables used by the device, and the free space of the storage location.

Preferably, the server further includes an order instructing unit providing an instruction concerning an order for the consumables according to the schedule for ordering the consumables that is planned by the planning unit.

Still preferably, the server further includes an operation instructing unit instructing the device to operate according to the instruction from the client.

Still preferably, the server further includes an operation ability storage unit storing ability in operation of the device.

Here, the calculating unit calculates the time required for the operation of the device, according to the instruction concerning the operation to be performed by the device and the ability in operation of the device.

Moreover, the planning unit plans the schedule for ordering the consumables according to the calculated time required for the operation of the device.

Preferably, the planning unit plans the schedule for ordering the consumables according to the time required for delivery of the consumables.

Preferably, when the free space of the storage location is enough to accommodate the number of lacking consumables that is determined according to the number of consumables used by the device and the number of consumables in stock, the planning unit plans the schedule for ordering all lacking consumables at a time.

According to another aspect of the present invention, a consumable management method for managing consumables includes the steps of storing the number of consumables in stock that are to be used by a device connected via a network, storing a free space of a storage location where the consumables are stocked, receiving from a client an instruction concerning an operation to be performed by the device, calculating the number of consumables used by the device according to the instruction concerning the operation, and planning a schedule for ordering the consumables according to the number of consumables in stock, the number of consumables used by the device, and the free space of the storage location.

According to still another aspect of the present invention, a consumable management program product is used for allowing a computer to perform a consumable management process for managing consumables. The consumable management process includes the steps of receiving from a client an instruction concerning an operation to be performed by a device connected via a network, calculating the number of consumables used by the device according to the instruction concerning the operation, and planning a schedule for ordering the consumables, according to the number of consumables used by the device, the number of the consumables in stock that is stored in advance, and a free space of a storage location where the consumables are stocked, so that the ordered consumables are accommodated in the free space.

According to a further aspect of the present invention, a system includes a device connected to a network for performing an operation using consumables, and a server receiving from a client an instruction concerning the operation by the device and calculating the number of the consumables used by the device to plan a schedule for ordering the consumables according to the number of consumables in stock and a free space of a storage location where the consumables are stocked.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a system for automatically issuing instructions concerning orders for consumables.

FIG. 2 is a block diagram showing a configuration of a print server 10 shown in FIG. 1.

FIG. 3 is a flowchart illustrating a process of issuing an instruction concerning an order for consumables that is carried out by the system shown in FIG. 1.

FIG. 4 is a flowchart illustrating a process of ordering sheets of paper that is carried out in step S202 of FIG. 3.

FIG. 5 is a flowchart illustrating a process of planning a schedule for ordering sheets that is carried out by print server 10 in step S306 of FIG. 4.

FIG. 6 shows a specific example of a job ticket transmitted from a client to the system.

FIG. 7 shows a specific example of sheet stock information.

FIG. 8 shows a specific example of information about the print processing speed of printer 20.

FIG. 9 shows a specific example of an order form used for ordering sheets.

### DESCRIPTION OF THE PREFERRED EMBODIMENTS

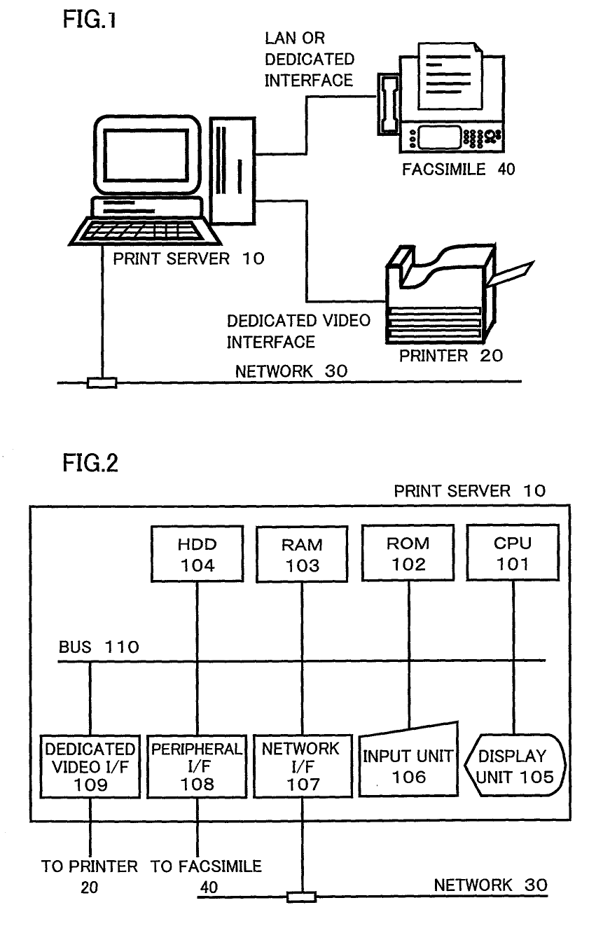

Referring to FIG. 1, a system for automatically issuing instructions concerning orders for consumables (this system is hereinafter referred to as system) includes a print server 10, a printer 20 and a facsimile 40.

Print server 10 is connected to a network 30.

Print server 10 and printer 20 are connected to each other by a dedicated video interface.

Print server 10 and facsimile 40 are connected to each other by a LAN (Local Area Network) or dedicated interface.

Printer 20 forms an image of data in a bitmap format or compressed bitmap format that is transferred from print server 10. According to this embodiment, printer 20 further has functions of making a two-sided print and of finishing like stapling, punching and folding for example.

Facsimile 40 receives, from print server 10, an instruction concerning an order for sheets of paper, and transmits the instruction in the form of an order form to a sheet supplier via the telephone line.

A configuration of print server 10 shown in FIG. 1 is described below in conjunction with FIG. 2. Print server 10 is a generally used computer and FIG. 2 shows a configuration of the general computer.

Referring to FIG. 2, print server 10 includes a CPU (Central Processing Unit) 101, a ROM (Read-Only Memory) 102, a RAM (Random-Access Memory) 103, an HDD 104, a display unit 105, an input unit 106, a network I/F 107, a peripheral I/F 108, and a dedicated video I/F 109. These components are connected to each other by a bus 110.

CPU 101 reads a program to execute the program, and outputs results of the execution.

ROM 102 stores a control program including a BIOS (Basic Input Output System) for example and data.

RAM 103 temporarily stores the program and data and serves as an area for execution by CPU 101.

HDD 104 stores various programs including an operating system and data.

Display unit 105 is constituted of a display for example. Display unit 105 shows various types of information by an image.

Input unit 106 is constituted of a pointing device like a mouse and a keyboard for example. Input unit 106 accepts entered information in various types.

Network I/F 107 is an interface used for mutual communication with other devices via network 30.

Print server 10 and printer 20 communicate with each other via dedicated video I/F 109.

Print server 10 and facsimile 40 communicate with each other via peripheral I/F 108.

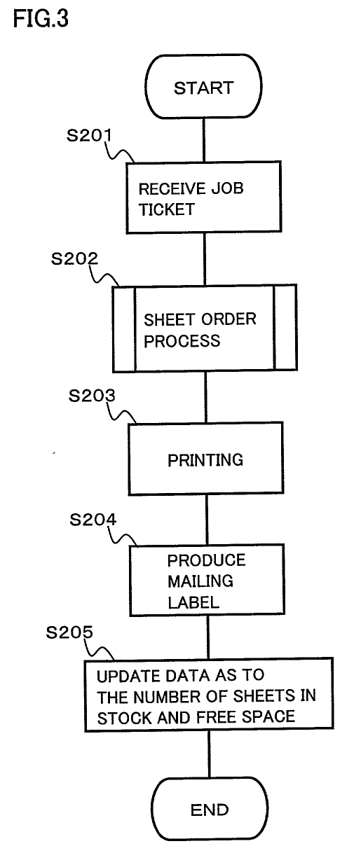

In conjunction with FIG. 3, a process is described that is performed by this system for automatically issuing an instruction concerning an order for consumables. The process shown in FIG. 3 starts from reception of a print instruction and ends with transmission of a resultant print.

Referring to FIG. 3, print server 10 receives from a client an instruction to make a print via network 30 (S201).

In step S201, print server 10 receives from the client the print instruction in the form of a job ticket which is detailed later based on a specific example thereof.

In accordance with the print instruction received in step S201 and at the time when print server 10 receives the print instruction, server 10 orders sheets (this operation is hereinafter referred to as sheet order process) (S202). The sheet order process in step S202 is later detailed in connection with a flowchart.

Print server 10 further performs a printing operation by means of printer 20 (S203) according to the print instruction received from the client in step S201.

Further, according to the print instruction received in step S201, a mailing label is created (S204). The mailing label created in step S204 is attached to the printed matter produced through the printing operation in step S203. The printed matter is thus dispatched to a destination designated by the client.

Then, data regarding sheets in stock as well as data regarding a free space of a storage location that are stored in HDD 104 of print server 10 are updated (S205).

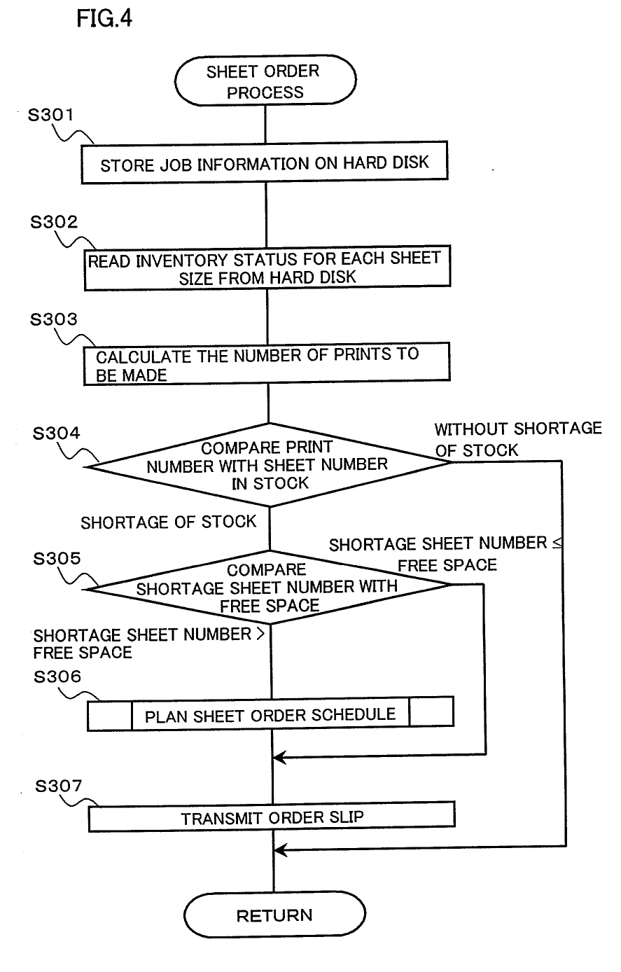

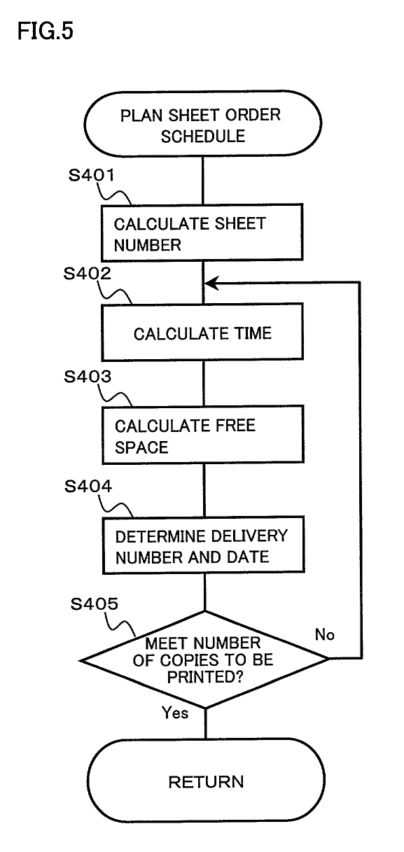

The sheet order process in step S202 of FIG. 3 is described below in connection with FIG. 4.

Referring to FIG. 4, CPU 101 of print server 10 stores, in HDD 104, job information and document information included in various types of information written on the job ticket received in step S201 of FIG. 3 (S301). In step S301, the job information and document information may be stored in another storage unit like RAM 103 for example. The job information and document information are described later together with the job ticket.

From HDD 104, CPU 101 of print server 10 reads the number of stocked sheets of the size necessary for making prints thereon as per the instruction from the client received in step S201, as well as a free space of the storage location (S302).

Further, CPU 101 calculates, from the job information and document information stored in HDD 104 for example in step S301, the number of sheets necessary for making prints thereon for each sheet size (S303).

CPU 101 of print server 10 compares the number of sheets in stock for each sheet size that is read in step S302 with the number of sheets necessary for making prints thereon that is calculated in step S303 (S304).

Upon the comparison in step S304, if the number of sheets in stock is greater than the number of sheets necessary for making prints thereon (without shortage of stock in S304), CPU 101 determines that there is a sufficient number of sheets in stock and accordingly proceeds to step S203 of FIG. 3 for making prints.

Upon the comparison in step S304, if the number of sheets in stock is smaller than the number of sheets necessary for making prints thereon (shortage of stock in S304), CPU 101 determines that there is a shortage of sheets in stock to proceed to step S305 and subsequent steps.

Then, CPU 101 of print server 10 calculates, for each sheet size, the number of lacking sheets corresponding to the shortage. Further, CPU 101 compares the calculated number of lacking sheets with the free space of the storage location that is read from HDD 104 for example in step S302 (S305).

Upon the comparison in step S305, if the number of lacking sheets corresponding to the shortage exceeds the free space of the storage location (shortage sheet number>free space in S305), CPU 101 determines that the number of lacking sheets is greater than the free space.

In this case, if CPU 101 of print server 10 operates to replenish the free space with the whole number of lacking sheets at a time, the supplied sheets exceed the free space of the storage location.

Thus, based on the job information stored in the storage unit in step S301, the number of lacking sheets calculated in step S305, information regarding the processing speed of printer 20 that is stored in advance in the storage unit, and information regarding the free space of the storage location read in step S302, CPU 101 of print server 10 plans a schedule for placing a plurality of orders for sheets (S306, hereinafter referred to as sheet order schedule).

The step in S306 of planning the sheet order schedule by print server 10 is later detailed in connection with a flowchart.

Upon the comparison in step S305, if the number of lacking sheets corresponding to the shortage is smaller than the free space of the storage location (shortage sheet number≦free space in S305), CPU 101 determines that, even if the free space is replenished with the whole number of lacking sheets at a time, there is still a room in the free space of the storage location. Accordingly, CPU 101 operates to order the total number of lacking sheets at a time.

Print server 10 automatically produces an order slip for ordering sheets, in accordance with the sheet order schedule planned in step S306 or the determination in step S305 that the whole number of lacking sheets is to be ordered at a time. Then, print server 10 transmits the order slip to a supplier of the sheets by means of facsimile 40 (S307).

In connection with FIG. 5, the planning of the sheet order schedule by print server 10 in step S306 of FIG. 4 is described.

Referring to FIG. 5, CPU 101 of print server 10 calculates, for each sheet size, the number of sheets necessary for printing one copy, based on the job information and document information on the job ticket received from the client in step S201 of FIG. 3 (S401).

If printing is performed by using the sheets in stock, the number of copies that can be printed is calculated. From the calculated number of printable copies as well as the information regarding the processing speed of printer 20 that is read from HDD 104, the time required for performing printing on the number of sheets in stock is calculated (S402). Accordingly, it is determined when the printing operation is finished for the current number of sheets in stock.

Further, a free space of the storage location that is left after the printing operation for the sheets in stock is calculated (S403). Then, the maximum number of sheets to be restocked is determined.

CPU 101 of print server 10 fixes a delivery date of sheets so as to allow ordered sheets to be delivered before the time, calculated in step S402, when printing is finished for the sheets in stock. Moreover, it is determined how many sheets are to be delivered that can be accommodated within the free space of the storage location calculated in step S403. Then, the schedule for ordering the sheets is planned (S404).

CPU 101 of print server 10 always monitors whether or not the current number of sheets in stock satisfies the number of copies to be printed that is written on the job ticket (S405).

Until the number of sheets in stock satisfies the number of copies to be printed that is shown on the job ticket, the step (S402) of calculating the time when the printing operation is finished for the current number of sheets in stock, the step (S403) of calculating the free space, and the step (S404) of determining the sheet delivery date and the number of sheets to be delivered are repeated.

The process illustrated in FIGS. 3-5 for automatically issuing instructions concerning orders for consumables is hereinafter detailed with reference to specific examples.

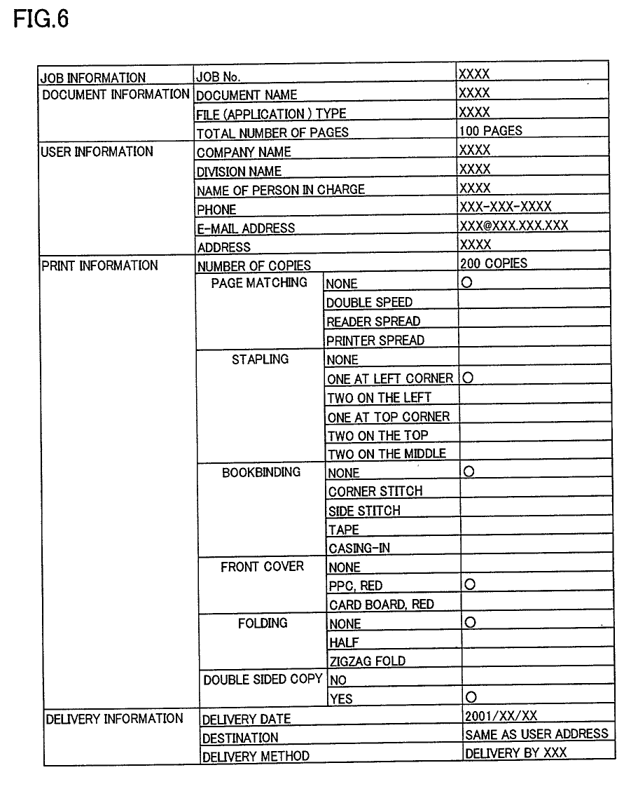

The job ticket is specifically described first in connection with FIG. 6.

The job ticket means a job sheet or job order. The job ticket in a broad sense refers to an instruction sheet or worksheet used for each job.

According to this embodiment, in step S201 of FIG. 3, the client transmits the job ticket shown in FIG. 6 to the system and accordingly gives an instruction concerning printing.

Referring to FIG. 6, the job ticket according to this embodiment includes: job information regarding a print job itself, job number for example; document information including the name of a document for example that is to be printed, the type of a file produced, and size information regarding the total number of pages for example; user information including the name of a company of the client, the name of a section placing an order, the name of a person in charge, and address and telephone number for example where contact should be made; print information including the number of copies to be printed and finishing; and delivery information including a delivery date, a destination to which printed matters should be delivered, and a way of delivering, for example.

The job ticket shown in FIG. 6 is produced by means of a home page (not shown) of the system, through which the client enters instructions. Then, the produced job ticket is transmitted to print server 10 through network 30 which is the Internet.

The job ticket shown in FIG. 6 may automatically be produced according to an instruction sheet transmitted from the client through network 30 to print server 10 in the form of an electronic mail.

Alternatively, the job ticket shown in FIG. 6 may be entered by an operator using input unit 106 of print server 10 according to an instruction sheet transmitted from the client to facsimile 40.

In step S301 of FIG. 4, the job information and document information of the job ticket shown in FIG. 6 are stored in HDD 104 of print server 10.

In step S303 of FIG. 4, CPU 101 of print server 10 calculates, based on the job information and document information included in the job ticket shown in FIG. 6, the number of sheets of each sheet size that are necessary for making prints thereon by printer 20.

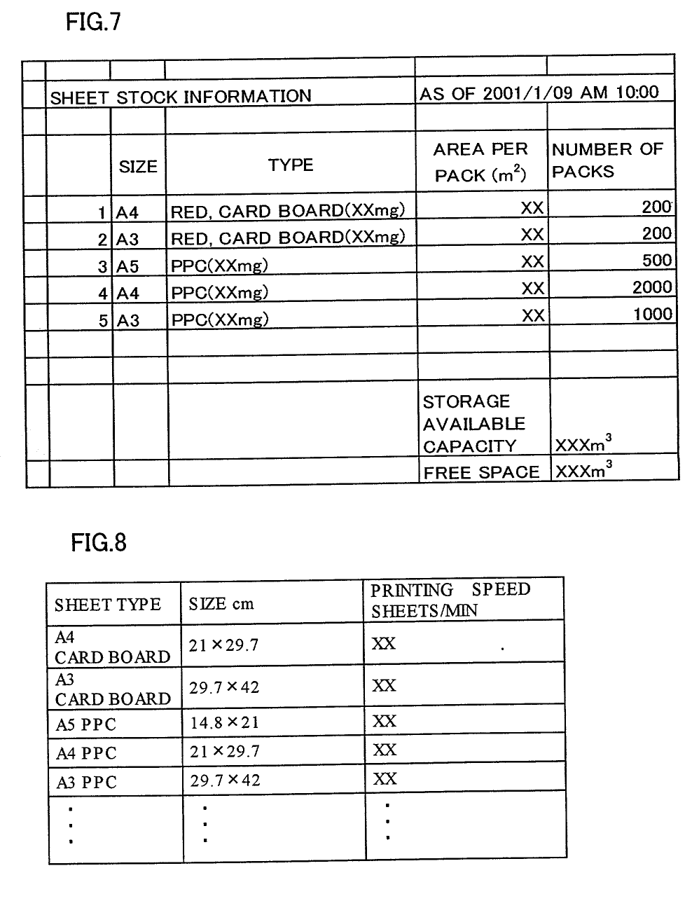

In connection with FIG. 7, information regarding sheets in stock (hereinafter referred to as sheet stock information) is specifically described below.

The sheet stock information includes the type and number of sheets in stock that are kept to be supplied to printer 20. The sheet stock information is stored in HDD 104 of print server 10.

Referring to FIG. 7, the sheet stock information according to this embodiment includes information about the type of sheets for each sheet size, information about the area per one pack of sheets, information about the number of packs of sheets in stock, information about the capacity of a sheet storage location or space, for example, in which the sheets can be accommodated, and information about a free space.

The sheet stock information shown in FIG. 7 may further include, if there are a plurality of storage locations, information for each storage location.

The sheet stock information shown in FIG. 7 may further include information about sheets held in printer 20. In this case, printer 20 may regularly transmit information about the sheets held therein to print server 10 via dedicated video I/F 109. Print server 10 may regularly request printer 20 to provide the information about the sheets stored in printer 20. When print server 10 receives the job ticket from the client in step S201 of FIG. 3, print server 10 may request printer 20 to provide the information about sheets stored in printer 20 and then receive that information.

The sheet stock information shown in FIG. 7 is automatically updated by print server 10 each time printer 20 performs printing operation, based on the sheet stock information before the printing operation and information as to the number of sheets used in the printing operation. The sheet stock information may be entered by an operator from input unit 106 of print server 10.

The sheet stock information shown in FIG. 7 may automatically be produced by calculation and updated according to the mass and volume for example of sheets that are automatically measured at the storage location.

The sheet stock information shown in FIG. 7 may be updated in step S205 of FIG. 3 when the number of sheets in stock changes. In addition, the sheet stock information may regularly be updated.

The sheet stock information is represented in FIG. 7 by the number of sheet packages (packs) by which sheets are delivered. The sheet stock information may alternatively be represented by another parameter such as the number of sheets and mass.

CPU 101 of print server 10 compares, in step S304 of FIG. 4, the number of sheets necessary for printing that is calculated in step S303, with the number of sheets in stock for each sheet size that is read from the sheet stock information shown in FIG. 7. Accordingly, in step S304, it is determined whether there is a shortage of sheets in stock when the print instruction provided from the client is executed.

CPU 101 of print server 10 further compares, in step S305 of FIG. 4, the number of lacking sheets corresponding to the shortage as determined in step S304 with the free space of the sheet storage location that is read from the sheet stock information shown in FIG. 7. Accordingly, it is determined if an order is placed or not for sheets to be delivered at a time.

In step S305 of FIG. 4, if it is determined that the number of lacking sheets exceeds the free space of the sheet storage location and then it is ordered that all of the required sheets should be delivered at a time, the delivered sheets overflow the free space. Then, in step S306, CPU 101 of print server 10 plans a schedule for placing an order for the number of sheets that do not overflow the free space of the sheet storage location and that are sufficient for printing to be executed.

In connection with FIG. 8, information about the print processing speed (hereinafter printing speed) of printer 20 is specifically described.

Referring to FIG. 8, according to this embodiment, the information about the printing speed includes information about printing speed of printer 20 for each sheet size and each sheet type. The information about printing speed may include information about printing speed of printer 20 for each data size to be printed.

The information about printing speed of printer 20 shown in FIG. 8 may be read automatically into HDD 104 for example of print server 10 when the system shown in FIG. 1 is implemented. The information about printing speed may alternatively be entered by an operator from input unit 106 into HDD 104 for example of print server 10.

CPU 101 of print server 10 reads from HDD 104, in step S402 of FIG. 5, the information about printing speed of printer 20 shown in FIG. 8.

CPU 101 of print server 10 calculates, in step S402 of FIG. 5, the time required for producing prints on the number of sheets in stock, according to the number of copies that can be printed by using sheets in stock as well as the printing speed included in the information about printing speed of printer 20 shown in FIG. 8.

CPU 101 of print server 10 further calculates, in step S403 of FIG. 5, a free space of the storage location that is left after prints are produced on the sheets in stock, according to the free space of the sheet stock information shown in FIG. 7 and the number of copies which can be printed on the sheets in stock that is calculated in step S401.

In step S404 of FIG. 5, CPU 101 of print server 10 plans a schedule for ordering sheets that are delivered to be accommodated in the free space of the storage location before printing is finished for the sheets in stock.

In accordance with the schedule planned in step S404 of FIG. 5, sheets are stocked to allow printer 20 to continue printing operation without pause.

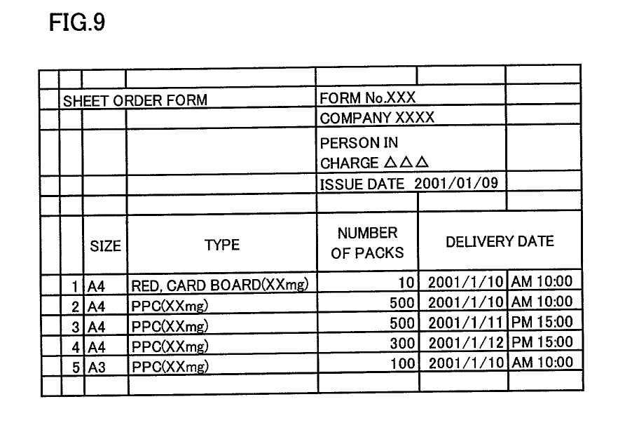

In connection with FIG. 9, an order form for ordering sheets (hereinafter referred to as sheet order form) is specifically described.

Referring to FIG. 9, according to this embodiment, the sheet order form includes information about the number of ordered sheet packs and information about delivery date for each sheet size and sheet type.

The sheet order form shown in FIG. 9 may include, if there are a plurality of sheet storage locations, information about locations to which sheets should be delivered. The sheet order form may include information about delivery method for example. The sheet order form is represented in FIG. 9 by the number of sheet packages (packs) by which sheets are delivered. The sheet order form may alternatively be represented by another parameter such as mass or the number of sheets.

The sheet order form shown in FIG. 9 is automatically produced in step S307 of FIG. 4 that is transmitted to a sheet supplier by facsimile 40. Alternatively, an operator who confirms information about an order for sheets indicated on display unit 105 of print server 10 may produce the sheet order form and thereafter transmit the order form to the sheet supplier by facsimile 40.

The operator may handle the transmission by facsimile 40. Alternatively, the sheet order form shown in FIG. 9 that is produced by print server 10 may thereafter be transmitted automatically by facsimile 40.

For the sheet order form shown in FIG. 9, print server 10 may create data about the order form which is thereafter transmitted through network 30 to a system of the sheet supplier. In this case, the system shown in FIG. 1 may not include facsimile 40.

The system of the present invention is used for ordering sheets to be consumed by printer 20 and accordingly described above. However, the system may be used for automatically ordering all kinds of consumables including sheets and items except for sheets that are used by printer 20.

Printer 20 shown in FIG. 1 performs not only printing but also such finishing operations as stapling, punching and bookbinding, according to specific instructions indicated on the job ticket shown in FIG. 6. Then, not only the stock of sheets for printing but also stock of consumables necessary for such finishing must be managed.

The system discussed above can be used for managing consumables including staples and bookbinding tapes as done for sheets of paper.

In this case, in the sheet stock information shown in FIG. 7 and stored in HDD 104 for example of print server 10, information is recorded concerning stock of such consumables as staples and bookbinding tapes.

Here, HDD 104 of print server 10 stores information about the processing speed of printer 20 that includes information about the printing speed as shown in FIG. 8 and information about finishing speed of printer 20.

In steps S302-304 of FIG. 4, CPU 101 of print server 10 determines, according to information about stock of consumables as well as the number of consumables to be used by printer 20, whether of not a required stock of consumables is secured.

If the stock of consumables is not secured, CPU 101 of print server 10 determines, depending on the free space of the storage location, if an order is placed for consumables to be delivered at a time or an order schedule is planned for ordering consumables.

The order schedule is planned, in a similar manner to the process shown in FIG. 5, by determining the number of consumables to be delivered and the delivery date, according to the number of consumables to be used by printer 20 that is calculated from the instruction indicated on the job ticket, the processing time calculated from the processing speed of printer 20 and information about stock of consumables. CPU 101 of print server 10 automatically places an order with a consumable supplier in step S307 of FIG. 4 in accordance with the planned schedule.

An order form for placing the order for consumables includes, as the sheet order form shown in FIG. 9, the type, number, delivery date of consumables, and the order form is transmitted to the supplier as the sheet order form shown in FIG. 9.

With regard to this embodiment, the network equipment or device included in the system is limited to printer 20 and accordingly the system is described as the one for printing operation. However, the system may include such network equipment as copying machine and facsimile, instead of printer 20, that performs a similar operation to that of printer 20. In this case, print server 10 manages the network equipment as does for printer 20. Then, instructions concerning order for consumables can automatically be issued in a similar manner.

The system discussed above receives a job ticket to automatically analyze details of printing operation indicated on the ticket. Accordingly, the system automatically orders missing or lacking consumables. It is thus possible to reduce or avoid downtime due to occurrence of stockout of consumables and accordingly improve business efficiency.

Further, the system discussed above can receive required consumables when the need therefor arises, which means that a user can reduce the storage space for consumables and thus cut the cost for securing the storage space. Consequently, a remarkable cost reduction is achieved.

Moreover, the system can calculate a free space of a storage location and an estimated printing speed to reduce the inventory. At the same time, the system can order consumables in accordance with a plan without causing downtime. A user can further reduce the storage space, which means that a more remarkable cost reduction is achieved.

In addition, the system can order consumables according to the pace of printing operation, which allows the printing operation and ordering operation to simultaneously be performed for required quantities only. The user can thus proceed with business activities without stock of consumables. In other words, the user can efficiently develop business activities without redundancy in terms of time and resource.

The method of automatically issuing orders for consumables that is employed by the above-described system may be provided as a program. Such a program may be recorded on such a computer-readable recording medium as flexible disk, CD-ROM, ROM, RAM and memory card that are attached to a computer as well as a hard disk included in the computer, and accordingly provided as a program product. The program may be provided by being downloaded through a network. The provided program is installed on a hard disk, read onto a RAM and executed. The program product here includes a program itself and a recording medium on which the program is recorded.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A server comprising:
a stock storage unit storing the number of consumables in stock that are to be used by a device connected via a network;
a free space storage unit storing a free space of a storage location where said consumables are stocked;
a receiving unit receiving from a client an instruction concerning an operation to be performed by said device;
a calculating unit calculating the number of consumables used by said device according to said instruction concerning the operation; and
a planning unit planning a schedule for ordering said consumables according to said number of consumables in stock, said number of consumables used by said device, and said free space of the storage location.

2. The server according to claim 1, further comprising an order instructing unit providing an instruction concerning an order for said consumables according to said schedule for ordering said consumables that is planned by said planning unit.

3. The server according to claim 1, further comprising an operation instructing unit instructing said device to operate according to said instruction from the client.

4. The server according to claim 1, further comprising an operation ability storage unit storing ability in operation of said device, wherein
said calculating unit calculates the time required for the operation of said device, according to the instruction concerning the operation to be performed by said device and the ability in operation of said device, and
said planning unit plans the schedule for ordering said consumables according to said calculated time required for the operation of said device.

5. The server according to claim 1, wherein
said planning unit plans the schedule for ordering said consumables according to a time when need for delivery of said consumables arises.

6. The server according to claim 1, wherein
when said free space of the storage location is enough to accommodate the number of lacking consumables that is determined according to said number of consumables used by said device and said number of consumables in stock, said planning unit plans the schedule for ordering all lacking consumables at a time.

7. A consumable management method for managing consumables, comprising the steps of:
storing the number of consumables in stock that are to be used by a device connected via a network;
storing a free space of a storage location where said consumables are stocked;
receiving from a client an instruction concerning an operation to be performed by said device;
calculating the number of consumables used by said device according to said instruction concerning the operation; and
planning a schedule for ordering said consumables according to said number of consumables in stock, said number of consumables used by said device, and said free space of the storage location.

8. The consumable management method according to claim 7, further comprising the step of providing an instruction concerning an order for said consumables according to said schedule for ordering said consumables that is planned in said step of planning.

9. The consumable management method according to claim 7, further comprising the step of outputting said schedule for ordering said consumables that is planned in said step of planning.

10. The consumable management method according to claim 7, wherein
in said step of planning, the schedule for ordering said consumables is planned according to ability of said device in operation using said consumables.

11. The consumable management method according to claim 7, wherein
in said step of planning, the schedule for ordering said consumables is planned according to a time when need for delievery of said consumables arises.

12. A consumable management program product for allowing a computer to perform a consumable management process for managing consumables, said consumable management process comprising the steps of:
receiving from a client an instruction concerning an operation to be performed by a device connected via a network;
calculating the number of consumables used by said device according to said instruction concerning the operation; and
planning a schedule for ordering said consumables, according to said number of consumables used by said device, the number of said consumables in stock that is stored in advance, and a free space of a storage location where said consumables are stocked, so that said ordered consumables are accommodated in said free space.

13. The consumable management program product according to claim 12, wherein
said consumable management process further comprises the step of providing an instruction concerning an order for said consumables according to said schedule for ordering said consumables that is planned in said step of planning.

14. The consumable management program product according to claim 12, wherein
said consumable management process further comprises the step of outputting said schedule for ordering said consumables that is planned in said step of planning.

15. The consumable management program product according to claim 12, wherein
in said step of planning of said consumable management process, the schedule for ordering said consumables is planned according to ability of said device in operation using said consumables.

16. The consumable management program product according to claim 12, wherein
in said step of planning of said consumable management process, the schedule for ordering said consumables is planned according to a time when need for delivery of said consumables arises.

17. A system comprising:
a device connected to a network for performing an operation using consumables; and
a server receiving from a client an instruction concerning the operation by said device and calculating the number of said consumables used by said device to plan a schedule for ordering said consumables according to the number of consumables in stock and a free space of a storage location where said consumables are stocked.

18. The system according to claim 17, wherein
said server calculates the time required for the operation according to ability in operation of said device to plan the schedule for ordering said consumables.

19. The system according to claim 17, wherein
said server plans the schedule for ordering said consumables according to a time when need for delivery of said consumables arises.

20. A server comprising:
a stock storage unit storing the number of consumables in stock that are to be used by an image forming device connected via a network;
a receiving unit receiving from a client an instruction concerning an operation to be performed by said image forming device;
a calculating unit calculating the number of consumables used by said image forming device according to said instruction concerning the operation; and
a planning unit planing a schedule for ordering said consumables according to said number of consumables in stock and said number of consumables used by said image forming device.
